(19) United States
(12) Patent Application Publication
(10) Pub. No.: US 2006/0021874 A1
(43) Pub. Date: Feb. 2, 2006

(54) Fabrication of ceramic interface electrochemical reference electrode

(76) Inventors: Shen-Kan Hsiung, Jhongli City (TW); Jung-Chuan Chou, Doouliou City (TW); Tai-Ping Sun, Jhongli City (TW); Chung-We Pan, Wandan Township (TW); Zheng-Cheng Chen, Yuanlin Township (TW)

Correspondence Address: JACOBSON HOLMAN PLLC, 400 SEVENTH STREET N.W., SUITE 600, WASHINGTON, DC, 20004, US

(21) Appl. No.: 11/137,551

(22) Filed: May 26, 2005

(30) Foreign Application Priority Data
Jul. 27, 2004 (TW) 093122410

(51) Int. Cl. G01N 27/327; H01R 43/16

(52) U.S. Cl. 204/435; 29/875

(57) ABSTRACT

In this present invention it was fabricated to be relates to manufacturing a ceramic interface electrochemical reference electrode for use together with biomedical sensors. Most potentiometric biomedical sensors must have the need to be connected to a reference electrode to offer the readout circuit a stable voltage in the different solutions when measuring for providing that can provide a standard comparing voltage to avoid measuring errors caused by an unstable environment. Usually, However, the presently available commercial reference electrode we used is too big in size and inconvenient to store. For this reason we develop the ceramic interface electrochemical reference electrode which can minimize volume and need not to be preserved in the saturated solution for biosensor. Therefore, the ceramic interface electrochemical reference electrode of the present invention does not need to be stored in solution and can be minimized for use in future sensors. In addition, the present invention also relates to a ceramic interface electrochemical reference electrode.

### FIELD OF THE INVENTION

This invention discloses the utilization of an acidity/alkalinity sensor component to manufacture a reference electrode that accompanies the acidity/alkalinity ion sensor component. This structure is made by using the film production and electrochemical reaction technology. In addition, the structure is then combined with the front-end of the acidity/alkalinity ion sensor component to constitute a complete biosensor system. Therefore, this invention can be used in the medical testing industry as well as in testing for environmental protection purposes.

### DESCRIPTION OF THE RELATED ART

Since the inventors are actively working towards developing a home-testing electrode for measuring the eight major parameters of bio-medical tests (concentrations of K, Na, Cl, Ca, pH, Urea, kreatininase, and blood oxygen), the objective of this invention is to provide patients with a cheaper and more convenient testing device that will enable them to know the status of their bodies. With this device, a patient will be able to go to hospital for more detailed diagnosis and treatment only when the parameters reach the dangerous levels. It not only saves a huge amount of medical and human resources at the hospital, but also enables the patients to keep track of the concentrations of their eight major parameters at any time and place and provide the data to their physicians for reference. However, during the measurement of the eight major parameters, it is necessary to have a reference electrode that is stable, not easily affected by the external environment and can change the base comparison electrical voltage. The reference electrodes currently available in the market, for example, S100C Ag/AgCl reference electrode (11751 Markon Dr. Garden Grove, Http://sorex.com/index2.html, Calif. 92841, USA), are rather expensive considering their usages and accuracy. This reference electrode is not cheap (NT$1,500-NT$2,000). Moreover, since it uses glass dialyzer as the contact solution interface, it can be easily broken. In addition, it is stored in a saturated Potassium chloride solution and it is inconvenient for portable use due to its large size. Therefore, this product is not suitable for use with the home-testing medical equipment currently under development by the inventors. The following research literatures of the foreign and domestic researchers have been referenced in the process of developing a suitable reference electrode. [Albrecht Uhlig, Frank Dietrich, Erno Lindner, Uwe Schnakenberg, Rainer Hintsche, “Miniaturized ion-selective sensor chip for potassium measurement in a biomedical application”, Sensors and Actuators B, Vol. 34, pp. 252-257, 1996.; Uwe Schnakenberg, Thomas Lisec, Rainer Hintsche, Ingrid Kuna, Albrecht Uhlig, Bernd Wagner, “Novel potentiometric silicon sensor for medical device”, Sensors and Actuators B, Vol. 34, pp. 476-480, 1996.; Chen-Yun Tian, Neng-Qin Jia, Rong Wang, Zong-Rang Zhang, Jian-Zhong Zhu, Guo-Xiong Zhang, “Microfabrication of chamber-type microchips and its applications for chemical sensors”, Sensors and Actuators B, Vol. 52, pp. 119-124, 1999.; Hiroaki Suzuki, Taishi Hirakawa, Satoshi Sasaki, Isao Karube, “Micromachined liquid-junction Ag/AgCl reference electrode”, Sensors and Actuators B, Vol. 46, pp. 146-154, 1998.; C. A. Galán-Vidl, J. Muñoz, C. Dominguez, S. Alegret, “Glucose biosensor strip in a three electrode configuration based on composite and biocomposite materials applied by planar thick film technology”, Sensors and Actuators B, Vol. 52, pp. 257-263, 1998.; Yongde Zou, Jinyuan Mo, “Ensembles of carbon paste micro-electrodes”, Analytica Chimica Acta, Vol. 382, pp. 145-150, 1999.; Chengxiao Zhang, Tetsuya Haruyama, Eiry Kobatake, Masuo Aizawa, “Disposable electrochemical capillary-fill device for glucose sensing incorporating a water-soluble enzyme/mediator layer”, Analytica Chimica Acta, Vol. 442, pp. 257-265, 2001.; Hiroaki Suzuki, Atsunori Hiratsuka, Satoshi Sasaki, Isao Karube, “Problems associated with the thin-film Ag/AgCl reference electrode and a novel structure with improved durability”, Sensors and Actuators B, Vol. 46, pp. 104-113, 1998.; Ansgar Erlenkotter, Mike Kottbus, Gabriele-Christine Chemnitius, “Flexible amperometric transducers for biosensors based on a screen printed three electrode system”, Journal of Electroanalytical Chemistry, Vol. 481, pp. 82-94, 2000.; S. D. Sprules, I. C. Hartley, R. Wedge, J. P. Hart, R. Pittson, “A disposable reagentless screen-printed amperometric biosensor for the measurement of alcohol in beverages”, Biosensors and Bioelectronics, Vol. 12, pp. 5-6, 1997.; Yi-Feng Tu, Zhi-Qiang Fu, Hong-Yuan Chen, “The fabrication and optimization of the disposable amperometric biosensor”, Sensors and Actuators B, Vol. 80, pp. 101-105; 2001.; Claudia Eggenstein, Michael Borchardt, Christoph Diekmann, Bernd Grundig, Christa Dumschat, Karl Cammann, Meinhard Knoll, Friedrich Spener, “A disposable biosensor for urea determination in blood based on an ammonium-sensitive transducer”, Biosensors and Bioelectronics, Vol. 14, pp. 33-41, 1999.; Jian Wu, Jan Suls, Willy Sansen, “Amperometric determination of ascorbic acid on screen-printing ruthenium dioxide electrode”, Electrochemistry Communications, Vol. 2, pp. 90-93, 2000.; Satoshi Ito, Hiromitu Hachiya, Keiko Baba, Yasukazu Asano, Hiroko Wada, “Improvement of the silver/silver chloride reference electrode and its application to pH measurement”, Talanta Vol. 42, pp. 1685-1690, 1995.; Beat Müller, Peter C. Hauser, “Effect of pressure on the potentiometric response of ion-selective electrode and reference electrodes”, Analytica Chimica Acta, Vol. 320, pp. 69-75, 1996.; Qingling Yang, Plamen Atanasov, Ebtisam Wilkins, “Development of needle-type glucose sensor with high selectivity”, Sensors and Actuators B, Vol. 46, pp. 249-256, 1998.; Maria Vamvakaki, Nikolas A. Chaniotakis, “Solid-contact ion-selective electrode with stable internal electrode”, Analytica Chimica Acta, Vol. 320, pp. 53-61, 1996.; Hyo Jung Yoon, Jae Ho Shin, Sung Dong Lee, Hakhyum Nam, Geun Sig Cha, Timothy D. Strong, Richard B. Brown, “Solid-state ion sensors with a liquid junction-free polymer membrane-based reference electrode for blood analysis”, Sensors and Actuators B, Vol. 64, pp. 8-14, 2000.; S. Taunier, C. Guery, J. M. Tarascon, “Design and characterization of a three-electrode electrochromic device, based on the system WO₃/IrO₂”, Electrochimica Acta, Vol. 44, pp. 3219-3225, 1999.; Fanping Kong, Frank McLarnon, “Spectroscopic ellipsometry of lithium/polymer electrolyte interfaces”, Journal of Power Sources, Vol. 89, pp. 180-189, 2000.; T. Matsumoto, A. Ohashi, N. Ito, “Development of a micro-planar Ag/AgCl quasi-reference electrode with long-term stability for an amperometric glucose sensor”, Analytica Chimica Acta, Vol. 460, pp. 253-259, 2002.; Ayumu Yasuda, Takeo Shimidzu, “Electrochemical carbon monoxide sensor with a Nafion film”, Reactive and Functional Polymers, Vol. 41, pp. 235-243, 1999.; J. J. Shyu, H. D. Chang, “Elemental distribution near the interfaces between cordierite-spodumene glass-ceramic Substrates and cofired Ag/Pd Electrodes,” Ceram. International, Vol. 26, pp. 289-293, 2000.

We derived the research and production methods for the reference electrodes, among which, one of the manufacturing methods and specifications of the product is found to be suitable for use as the home-testing medical device currently under development by the inventors. The following is a summary of the reference literature relevant to this invention.

Back Etching Method: According to this method, a groove of a suitable size is formed on a chip, and then the chip is plated with a layer of silver. This layer of silver is then processed through chlorine gas to form a silver chloride silver material. A conducting wire is then connected to the silver layer and the groove is filled with potassium chloride solution [See Albrecht Uhlig, Frank Dietrich, Erno Lindner, Uwe Schnakenberg, Rainer Hintsche, “Miniaturised ion-selective sensor chip for potassium measurement in a biomedical application”, Sensors and Actuators B, Vol. 34, pp. 252-257, 1996.; Uwe Schnakenberg, Thomas Lisec, Rainer Hintsche, Ingrid Kuna, Albrecht Uhlig, Bernd Wagner, “Novel potentiometric silicon sensor for medical device”, Sensors and Actuators B, Vol. 34, pp. 476-480, 1996.; Chen-Yun Tian, Neng-Qin Jia, Rong Wang, Zong-Rang Zhang, Jian-Zhong Zhu, Guo-Xiong Zhang, “Microfabrication of chamber-type microchips and its applications for chemical sensors”, Sensors and Actuators B, Vol. 52, pp. F19-124, 1999.; Hiroaki Suzuki, Aishi Hirakawa, Satoshi Sasaki, Isao Karube, “Micromachined liquid-junction Ag/AgCl reference electrode”, Sensors and Actuators B, Vol. 46, pp. 146-154, 1998].

Advantage: the size of the product can be minimized and the product is stable.

Disadvantages: This method is not a standardized method presently used to produce semi-conductors. Although it solves the minimization problem, it is not suitable for mass-production. Moreover, the cost of the etching solution and the silicon base board is not low. Therefore, this method is not suitable for making a sensor with reduced cost of production.

Screen Printing Method: According to this method, a silver powder and a special solution are firstly mixed and then spread on a base board before they are chloridized. [See C. A. Galan-Vidal, J. Mufioz, C. Dominguez, S. Alegret, “Glucose biosensor strip in a three electrode configuration based on composite and biocomposite materials applied by planar thick film technology”, Sensors and Actuators B, Vol. 52, pp. 257-263, 1998; Yongde Zou, Jinyuan Mo, “Ensembles of carbon paste micro-electrodes”, Analytica Chimica Acta, Vol. 382, pp. 145-150, 1999; Chengxiao Zhang, Tetsuya Haruyama, Eiry Kobatake, Masuo Aizawa, “Disposable electrochemical capillary-fill device for glucose sensing incorporating a water-soluble enzyme/mediator layer”, Analytica Chimica Acta, Vol. 442, pp. 257-265, 2001.; Hiroaki Suzuki, Atsunori Hiratsuka, Satoshi Sasaki, Isao Karube, “Problems associated with the thin-film Ag/AgCl reference electrode and a novel structure with improved durability”, Sensors and Actuators B, Vol. 46, pp. 104-113, 1998.; Ansgar Erlenkotter, Mike Kottbus, Gabriele-Christine Chemnitius, “Flexible amperometric transducers for biosensors based on a screen printed three electrode system”, Journal of Electroanalytical Chemistry, Vol. 481, pp. 82-94, 2000.; S. D. Sprules, I. C. Hartley, R. Wedge, J. P. Hart, R. Pittson, “A disposable reagentless screen-printed amperometric biosensor for the measurement of alcohol in beverages”, Biosensors and Bioelectronics, Vol. 12, pp. 5-6, 1997.; Yi-Feng Tu, Zhi-Qiang Fu, Hong-Yuan Chen, “The fabrication and optimization of the disposable amperometric biosensor”, Sensors and Actuators B, Vol. 80, pp. 101-105, 2001.; Claudia Eggenstein, Michael Borchardt, Christoph Diekmann, Bernd Grundig, Christa Dumschat, Karl Cammann, Meinhard Knoll, Friedrich Spener, “A disposable biosensor for urea determination in blood based on an ammonium-sensitive transducer”, Biosensors and Bioelectronics, Vol. 14, pp. 33-41, 1999.; Jian Wu, Jan Suls, Willy Sansen, “Amperometric determination of ascorbic acid on screen-printing ruthenium dioxide electrode”, Electrochemistry Communications, Vol. 2, pp. 90-93, 2000.]

Advantage: This is the main method used for mass-production. The cost is low and the size of the reference electrode can also be minimized.

Disadvantages: The quality of the reference electrode manufactured with this method is not stable. It is commonly used as disposable reference electrodes.

Ceramic Material Method: According to this method, grounded potassium chloride grains of a suitable size are added to a Teflon (PTFE) powder according to a proper ratio. After being mixed, the mixture is then pressed and baked, and cut into appropriate size and shape thereafter. This ceramic material is then placed into a hollow tube and the tube is then filled with potassium chloride solution. A silver/chloride silver conducting wire is then connected to the unit. After being sealed and packaged, a reference electrode is completed. [See Satoshi Ito, Hiromitu Hachiya, Keiko Baba, Yasukazu Asano, Hiroko Wada, “Improvement of the silver/silver chloride reference electrode and its application to pH measurement”, Talanta Vol. 42, pp. 1685-1690, 1995; Beat Müller, Peter C. Hauser, “Effect of pressure on the potentiometric response of ion-selective electrode and reference electrodes”, Analytica Chimica Acta, Vol. 320, pp. 69-75, 1996; Qingling Yang, Plamen Atanasov, Ebtisam Wilkins, “Development of needle-type glucose sensor with high selectivity”, Sensors and Actuators B, Vol. 46, pp. 249-256, 1998.; Maria Vamvakaki, Nikolas A. Chaniotakis, “Solid-contact ion-selective electrode with stable internal electrode”, Analytica Chimica Acta, Vol. 320, pp. 53-61, 1996].

Advantage: The reference electrode has a long usage life and is stable.

Disadvantages: The reference electrode is not easy to produce and the size cannot be easily minimized.

Polymer Dialyzer Method: According to this method, a saturated potassium chloride solution and a silver/chloride silver conducting wire are covered with a polymer dialyzerin order to let the polymer Dialyzer become the interface between solutions. [See Hyo Jung Yoon, Jae Ho Shin, Sung Dong Lee, Hakhyum Nam, Geun Sig Cha, Timothy D. Strong, Richard B. Brown, “Solid-state ion sensors with a liquid junction-free polymer membrane-based reference electrode for blood analysis”, Sensors and Actuators B, Vol. 64, pp. 8-14, 2000; S. Taunier, C. Guery, J. M. Tarascon, “Design and characterization of a three-electrode electrochromic device, based on the system WO₃/IrO₂”, Electrochimica Acta, Vol. 44, pp. 3219-3225, 1999; Fanping Kong, Frank McLarnon, “Spectroscopic ellipsometry of lithium/polymer electrolyte interfaces”, Journal of Power Sources, Vol. 89, pp. 180-189, 2000.; T. Matsumoto, A. Ohashi, N. Ito, “Development of a micro-planar Ag/AgCl quasi-reference electrode with long-term stability for an amperometric glucose sensor”, Analytica Chimica Acta, Vol. 460, pp. 253-259, 2002.; Ayumu Yasuda, Takeo Shimidzu, “Electrochemical carbon monoxide sensor with a Nafion film”, Reactive and Functional Polymers, Vol. 41, pp. 235-243, 1999.; J. J. Shyu, H. D. Chang, “Elemental distribution near the interfaces between cordierite-spodumene glass-ceramic Substrates and cofired Ag/Pd Electrodes,” Ceram. International, Vol. 26, pp. 289-293, 2000.]

Advantages: The reference electrode made by this method has a long usage life and can be easily minimized.

Disadvantages: The reference electrode is not easily produced and the selectivity towards the ions of contaminants slow; therefore, it is easily affected by ions of contaminants.

The following is a list of existing relevant patents:

(I) D. C. Chan Andy, U.S. Patent, Patent Number: U.S. Pat. No. 6,416,646 Date of patent: Jul. 9, 2002, Title: “Method of making a material for establishing solid state contact for ion selective electrodes”. This patent discloses a polymer material methacrylamidopropyltrimethylammoniumchloride (MAPTAC) or methyllmethacrylate (MMA), which is used on the field transistor gate to produce an ion selective electrode. It has a certain level of stability and reproductively. The polymer membrane can be mixed with ion selective materials and used for solid electrodes. In the patent, it has been mentioned that the electrical charge of the polymer is 2.72 mEq per milligram. It has also been mentioned in another claim that the polymer contains dipole relative location charge and the structures are contained in an oxidation-reduction layer.

(II) Martijn Marcus Gabriel Antonisse, David Nicolaas Reinhoudt, Bianca Henriette Maria Snellink-Ruel, Peter Timmerman, U.S. Patent, Patent Number: U.S. Pat. No. 6,468,406 Date of patent: Oct. 22, 2002, Title: “Anion-complexing compound, method of preparing the same, an ion-selective membrane and a sensor provided with such a compound or membrane”. This patent discloses an application of alkali metal/alkaline earth ion selective material, which was synthesized organically to produce a chemical compound of a special functional group for example, —NHC(X)—, —C(X)NH—, —NHC(X) NH—, in which, X includes sulfur or oxygen atom and is added with a special structure of the chemical compound to achieve the selectivity to the ions of the alkali metal/alkaline earth.

(III) Massimo Battilotti, Giuseppina Mazzamurro, Matteo Giongo, U.S. Patent, Patent Number: U.S. Pat. No. 5,130,265, Date of patent: Dec. 21, 1989, Title: “Process for obtaining a multifunctional, ion-selective-membrane sensor using a siloxanic prepolymer”. This patent discloses a production process, in which light is used to harden the polymer. This production process is capable of affixing various types of ion selective materials onto micro components. In the patent specification, it is mentioned that the sensor component is produced by adding a solution of a light initiator to dissolve a silica gel and an ion selective material. The mixture is then pasted on the base board in a circular motion and the unit is then exposed to the UV light. Afterwards, the unit is washed with organic solutions and heated to harden the polymer. After repeating the process, a sensor electrode is completed on the same base board and this unit can be used to manufacture various ion field transistor sensor components.

(IV) Akihiko Mochizuki, Hideyo Iida, U.S. Patent, Patent Number: U.S. Pat. No. 4,921,591, Date of patent: May 1, 1990, Title: “Ion sensors and their divided parts”. This patent discloses an ion selective membrane including polymers containing hydroxyl and carbon ethylene polymer, which are fixed on an extended gate sensor field transistor. It has also been mentioned in the patent specification that the reference electrode is placed on the other side of the ion selective electrode and the ion selective electrode and reference electrode are separated. The reference electrode and the extended gate are made of different materials.

(V) Noboru Oyama, Takeshi Shimomura, Shuichiro Yamaguchi, U.S. Patent, Patent Number: U.S. Pat. No. 4,816,118, Date of patent: Mar. 28, 1989, Title: “Ion-sensitive FET sensor”. This patent discloses an ion selective electrode (ISFET), which is made by pulling out the gate pole of MOS-type field-effect transistor (MOSFET) and added with an ion selective membrane, in which the oxidation-reduction layer has the oxidation-reduction function and this function is helpful to increase the stability and effective time when the layer is placed in between the isolating membrane and ion selective membrane. The conductive layer or metal film affects the stability and durability of the isolating membrane and oxidation membrane. It has also been found in this invention that the ion selective layer can transport optimized ion materials.

In view of the results summarized from the above and the necessary conditions for measurement and production costs for the reference electrode, there has not been any in-depth studies on the preservation methods for micro reference electrodes among the patents in Taiwan at the current stage. Therefore, developing a micro reference electrode that is convenient to store and easy to use, which is a ceramic interface electrochemical reference electrode, is an objective of this invention.

In this application, we propose a ceramic electrochemical reference electrode that can be used as an electrical bio-medical sensor component. This invention emphasizes the method and device that provide a stable and less affectable reference electrode for use as an electrical bio-chemical sensor component.

### SUMMARY OF THE INVENTION

One objective of this invention is to provide a type of ceramic electro-chemical reference electrode for use as an electric bio-medical sensor component. This invention emphasizes the method and device that provide a stable and less affectable reference electrode for use as an electrical bio-chemical sensor component.

Another objective of this invention is to provide a production method for ceramic interface electrochemical reference electrode, which is to be used as a component for electrical bio-medical sensors.

To achieve the above objectives, the ceramic interface electrochemical reference electrode of this invention is intended to be used as a component on electrical bio-medical sensors. The ceramic interface electrochemical reference electrode is formulated with the Teflon (PTPE) and the potassium chloride (KCl) powders (grain size: 147 um-246 um) mixed at a weight ratio of 26:74. After the mixture is compressed, cut, and packaged, the finished blocks form the ceramic interface electrochemical reference electrodes, which achieve a sensitivity to various pH values of 0.0864 mV/pH. The sensitivity range of a pH sensor component combined with the ceramic electrochemical reference electrode is 57.54 mV/pH; the sensitivity range of the ceramic electrochemical reference electrode in a dry environment for 60 days is 0.141 mV/pH. When the component is under a moderate temperature range, for example, 0° C.-60° C., it has very good electrical voltage working characteristics.

To achieve the above objectives, the ceramic interface electrochemical reference electrode of this invention is produced by the following procedure: obtaining a first powder and a second powder of appropriate sizes by using a screening sieve; mixing the first powder and second powder at an appropriate weight ratio and putting them in a mould to compress the powder mixture for a prescribed first time period by using a ceramic compressor to form a cake; heating the compressed powder cakes by placing the compressed powder cakes into a kiln at a set temperature for a length of a second time period; after heating, cooling the product and cutting them into appropriate sizes as needed; taking out the chloride silver wires that have been processed through the first saturated powder solution, that is, the Ag/AgCl material; sealing and packaging the chloride silver wires with the ceramic material to form the ceramic interface electrochemical reference electrodes.

### BRIEF DESCRIPTION OF THE DRAWINGS

FIG. 1 is a schematic view of polytetrafluoroethylene (PTFE)/KCL bulk for the ceramic interface electrochemical reference electrode of the present invention.

FIG. 2 is a schematic view showing silver wire plating for the ceramic interface electrochemical reference electrode of the present invention.

FIG. 3 is a sectional view of the structure of the ceramic interface electrochemical reference electrode of the present invention.

FIG. 4 is a circuit diagram of the testing circuit.

FIG. 5 is a chart showing the sensitivity of the S100C reference electrode to various pH values.

FIG. 6 is a chart showing the sensitivity of pH sensor component combined with S100C reference electrode.

FIG. 7 is a chart showing the sensitivity of the ceramic interface electrochemical reference electrode of the present invention in buffer solutions of various pH values.

FIG. 8 is a chart showing the sensitivity of the pH sensor component combined with the ceramic interface electrochemical reference electrode of the present invention.

FIG. 9 is a chart showing the sensitivity of the S100C reference electrode to buffer solutions of various pH values after being preserved in saturated KCl solution for 60 Days.

FIG. 10 is a chart showing the sensitivity of the ceramic interface electrochemical reference electrode of the present invention to buffer solutions of various pH values after being placed in a dry environment for 30 Days.

FIG. 11 is a chart showing the electrical voltage values of the ceramic interface electrochemical reference electrode of the present invention to buffer solutions of various pH values after being placed in a dry environment for 30 Days.

FIG. 12 is a chart showing the sensitivity of the ceramic interface electrochemical reference electrode of the present invention to buffer solutions of various pH values after being a dry environment for 60 Days.

The meaning of the reference numerals used in the above figures is as follows:

| | |
|---|---|
| Power supply 1 | Platinum electrode pole 2 |
| Silver wire 3 | Saturated KCl solution 4 |
| Ag/AgCl silver conducting wire 5 | Packaging material epoxy 6 |

Polytetrafluoroethylene (PTFE)/KCl ceramic interface 7

| | |
|---|---|
| Negative power supply input terminal 8 | |
| Positive power supply input terminal 9 | Electrical voltage signal |
| | output terminal 10 |
| Reference electrode terminals 11 and 12 | |

### DETAILED DESCRIPTION OF THE PREFERRED EMBODIMENT

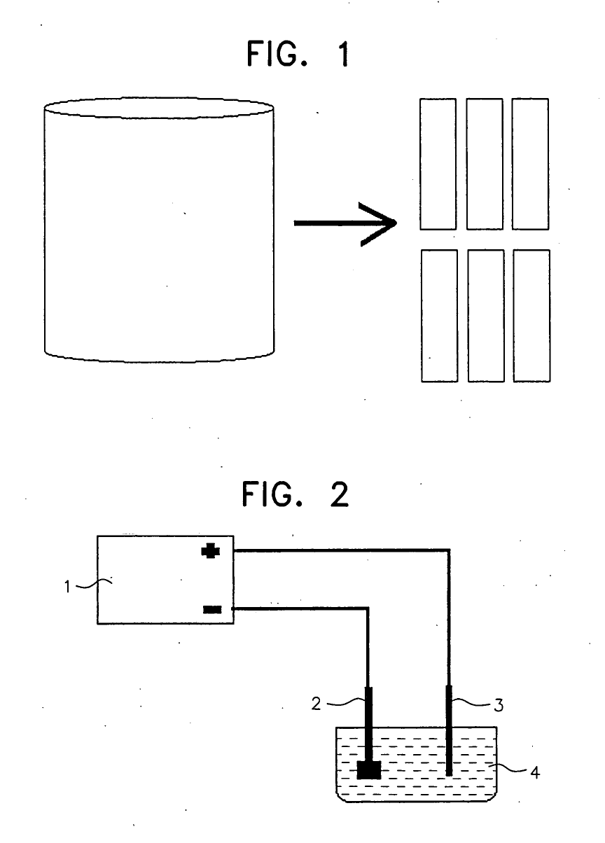

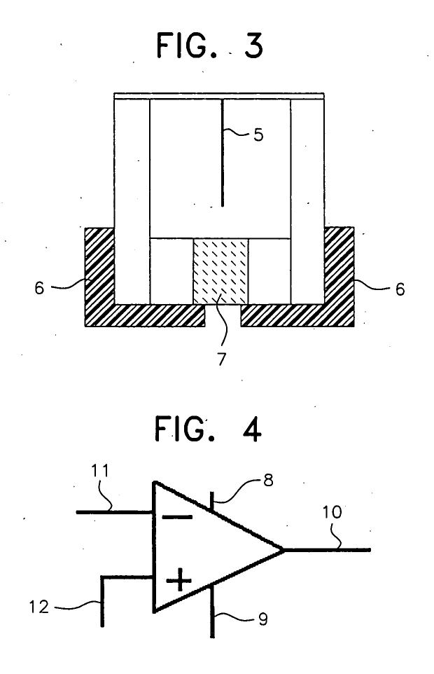

The production procedure for the ceramic interface electrochemical reference electrodes include the following steps: obtaining dried KCl and polytetrafluoroethylene (PTFE) powders to derive grains at approximate sizes of 14.7-29.5 nm by using screening sieves and mixing them at a weight ratio of 26% and 74% respectively; after mixing, putting the mixture into molds and compressing the mixture with a ceramic compressor at a force of 200 kg/cm² for five minutes; after compressing, putting the cakes into a kiln and heating up the products with 365° C. of temperature for 150 minutes; after heating and cooling, slicing the product into desired sizes as shown in FIG. 1; taking out the chloride silver wires (Ag/AgCl) from the potassium chloride (as shown in FIG. 2) and assembling the wires with the ceramic cakes as shown in FIG. 3. The ceramic interface electrochemical reference electrode is completed after packaging.

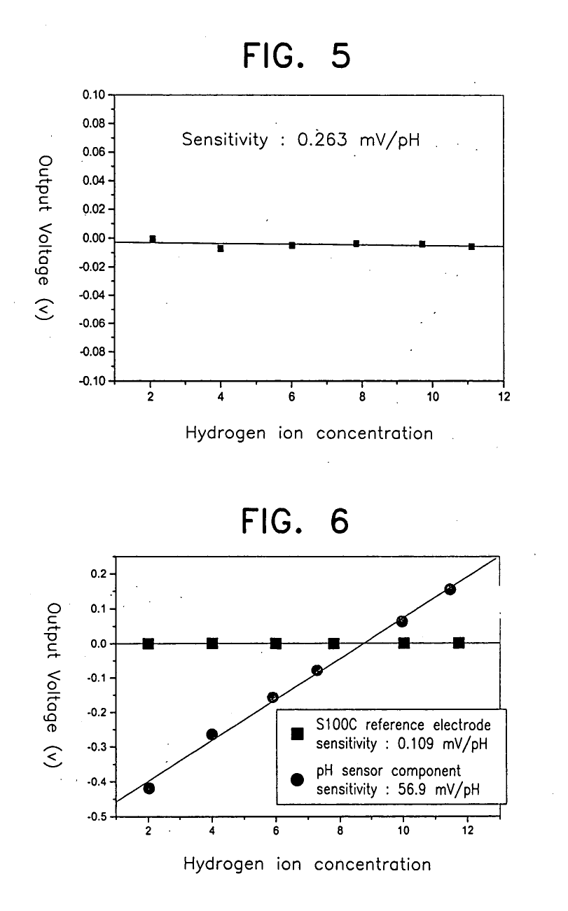

As shown in FIG. 4, a magnifier LT1167 is used as the read out circuit and one S100C glass reference electrode pole is connected to terminal 11, and another to terminal 12. The device is put into buffer solutions of various pH values, the results derived are as shown in FIG. 5. The S100C glass reference electrode pole is connected to terminal 11 and pH sensor component on terminal 12. The device is placed into buffer solutions of various pH values. The results shown in FIG. 6 are derived.

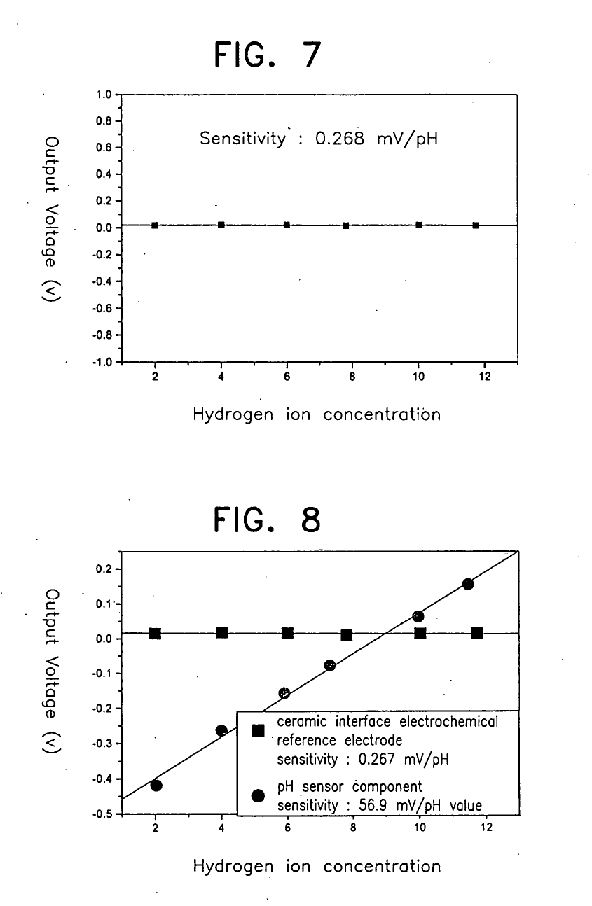

The S100C glass reference electrode pole is connected to terminal 11 and the ceramic interface electrochemical reference electrode is connected to terminal 12 before they are placed into buffer solutions of various pH values, results shown in FIG. 7 are derived. A ceramic interface electrochemical reference electrode is connected to terminal 11 and pH sensor component to terminal 12 before they are placed into buffer solutions of various pH values, results stated in FIG. 8 are derived.

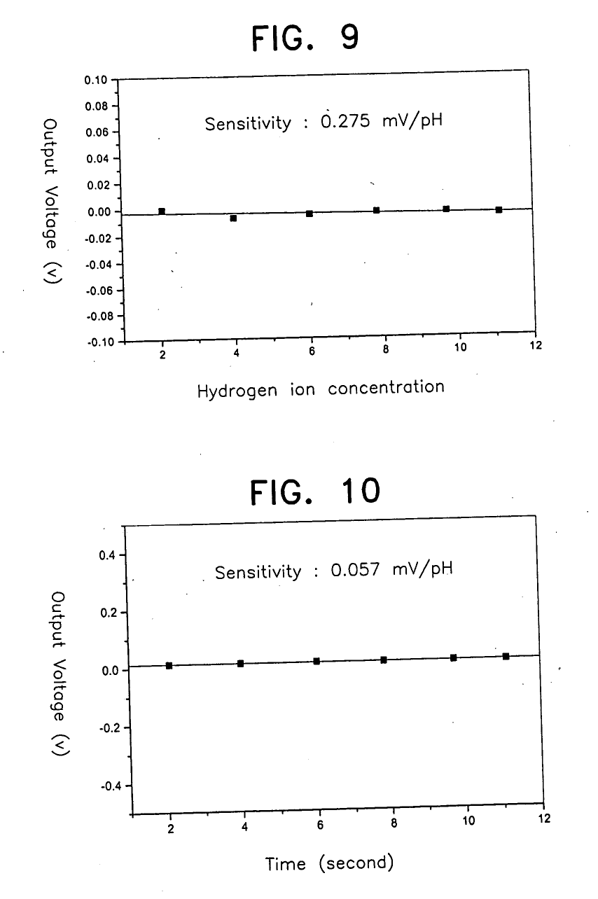

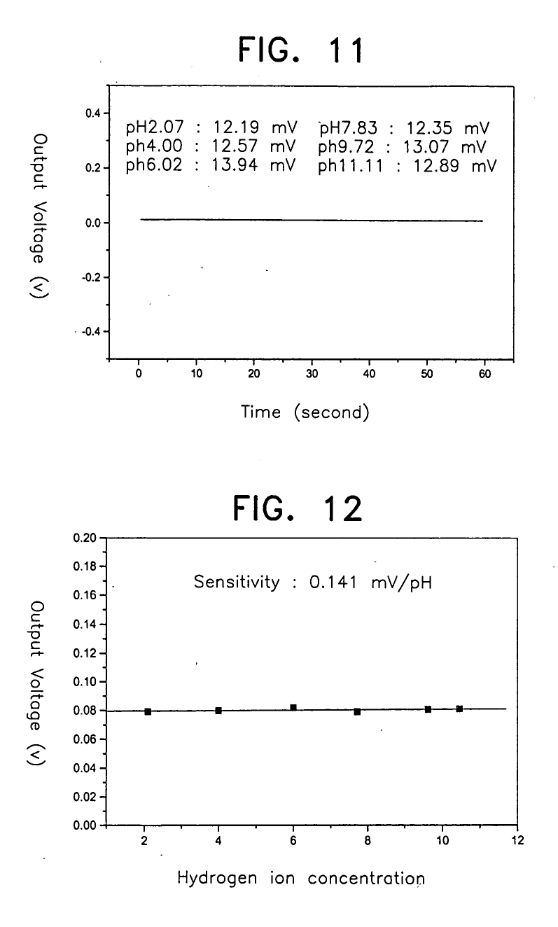

After a S100C glass reference electrode is placed into preservative solution for 60 days, results of tests on buffer solutions of various pH values as shown in FIG. 9 are derived. Reference specifications of various electrode products are shown in Table 2. After a ceramic interface electrochemical reference electrode is placed in a dry environment for 30 days, the voltage signals detected are shown in FIGS. 10 and 11. After a ceramic interface electrochemical reference electrode is placed in dry environment for 60 days, the voltage signals detected are shown in FIG. 12.

After a ceramic interface electrochemical reference electrode is placed in buffer solutions of various temperatures (0° C.-60° C.), the voltage signals detected under various temperatures are shown in Table 1.

The preferred embodiments are as follows:

(I) Production conditions (A): the production procedures of the ceramic interface electrochemical reference electrode are shown as follows:
1. compressing the mixture of polytetrafluoroethylene (PTFE) KCl;
2. heating the mixture with high temperature to a certain form;
3. slicing the heated polytetrafluoroethylene (PTFE) and KCl bulks into appropriate sizes with a ceramic cutter (as shown in FIG. 10;
4. placing silver wires (Ag) with KCl solution to produce Ag/AgCl wires (as shown in FIG. 2); and
5. packaging the products with Epoxy (as shown in FIG. 3).

(1) Production Conditions (B): specifications and production environments of each layer of the components are as follows:

In FIG. 2, there is a power supply 1 and the silver wires were electroplated in the saturated KCL solution for 30 minutes at a voltage of 3 volts. A platinum electrode pole 2 has a dimension of 5 mm². A silver wire 3 with a total length of 3 cm and has 2 cm of its length soaked in a saturated KCl solution 4.

In FIG. 3, there is a Ag/AgCl conducting wire 5 with a total length of 3 cm. A polytetrafluoroethylene (PTFE) and KCl ceramic interface 7 is in a drum shape with a diameter of 2 mm and height of 12 mm. The contact surface with the test solutions is minimized to a surface of a circle with a diameter of 1 mm by the packaging material—Epoxy.

FIG. 4 is a diagram of the testing circuit using a LT1167 instrument magnifier, which has an input terminal 8 of the 9-volt electrical voltage and an input terminal 9 of the negative 9-volt electrical voltage. There is an output end 10 for the electrical signals. The terminals 11, 12 are connected to the reference electrode.

From the results shown in FIG. 5, we find that the sensitivity of the S100C glass reference electrode in buffer solutions of various pH values is 0.263 mV/pH (as shown in FIG. 5), which indicates that there will be a change of 0.263 mV/pH as the pH values change by one level. Compared to the high sensitivity of the pH sensor component (55 mV/pH), conventional reference electrodes have very minimal effect during testing (0.263/55=0.48%). From FIG. 6, we derived that after connecting the S100C reference electrode to the pH sensor component and immersing it into buffer solutions of various pH values for electrical voltage testing, the S100C reference electrode provides a stable standard electrical voltage values for reference when testing is conducted by the pH sensor component. Moreover, from FIG. 7, we derive that when placing the ceramic interface electrochemical reference electrode into buffer solutions of various pH values, changes in the electrical voltage values used to detect various pH values incurred by the ceramic interface electrochemical reference electrode made according to the present method are similar to that of the S100C reference electrode (0.268/55=0.48%). In addition, from FIG. 8, we found that when the ceramic interface electrochemical reference electrode is connected to the pH sensor component and placed in buffer solutions of various pH values, the electrical voltages derived during testing are as stable as the electrical voltage provided by the S100C reference electrode, which can be used as a stable reference standard electrical voltage value.

From FIG. 9, we derived the lifetime characteristics of the S100C reference electrode. From this result, it is discovered that the voltage characteristics of the conventional S100C reference electrode preserved in a saturated KCl solution yields are not significantly different after it is in the solution for 60 days. According to FIGS. 10 and 11, the ceramic electrochemical reference electrode was stored in a dry environment for 30 days. From the electrical voltage value and sensitivity results obtained by placing the electrode in buffer solutions of various pH values, it is discovered that the ceramic electrochemical reference electrode still has favorable reference electrode characteristics even after being placed in a dry environment for 30 days. In addition, from FIG. 12, we found that the ceramic interface electrochemical reference electrode still has favorable reference electrode characteristics after it is placed in a dry environment for 60 days, which indicates that the lifetime of reference electrode in dry environments is effectively upgraded. Moreover, the ceramic interface electrochemical reference electrode does not need to be placed in KCl solutions for preservation, which provide higher level of convenience for preservation than the S100C reference electrode.

Table 1 is a table showing the electrical voltage values sensitivity of the ceramic interface electrochemical reference electrode of the present invention to buffer solutions of various pH values after being placed in temperatures between 0C˜60° C. Table 1 shows electrical voltage values of the ceramic interface elelctrochemical reference electrode when it is placed in various buffer solution with various pH at the temperature of 0C˜60° C. It is found that when the ceramic interface electrochemical reference electrode is placed in buffer solutions of various temperatures (0° C.˜60° C.), the external environment does not have significant effects on the reference electrode.

TABLE 1
Unit: mV

| | | pH | pH | pH | pH | pH | pH | Sensitivity |
|---|---|---|---|---|---|---|---|---|
| | | 2.11 | 4.02 | 6.01 | 7.88 | 9.77 | 11.55 | mV/pH |
| 0° | C. | 0.47 | −6.83 | −7.07 | −1.09 | 2.83 | −0.74 | 0.42 |
| 5° | C. | 1.03 | −6.33 | −5.96 | 1.72 | −3.98 | 0.91 | 0.21 |
| 10° | C. | 1.31 | −6.11 | −5.99 | 1.88 | −4.40 | 0.67 | 0.14 |
| 15° | C. | −1.10 | 4.03 | 0.67 | −0.85 | 4.03 | −1.13 | 0.02 |
| 20° | C. | −0.86 | 3.72 | 1.02 | −0.09 | 3.39 | −0.53 | 0.05 |
| 25° | C. | −1.68 | 2.78 | 0.96 | 1.00 | −4.44 | −0.17 | 0.02 |
| 30° | C. | −0.40 | −1.60 | −0.70 | −1.80 | −2.20 | −1.00 | 0.09 |
| 35° | C. | 1.40 | 1.50 | 1.80 | 2.10 | 2.00 | 1.40 | 0.03 |
| 40° | C. | 2.20 | 0.90 | 1.20 | 1.00 | 1.30 | 1.00 | 0.08 |
| 45° | C. | 1.30 | 1.00 | 1.10 | 0.70 | 1.10 | 1.00 | 0.02 |
| 50° | C. | 1.10 | 1.40 | 1.30 | 1.20 | 0.60 | 1.00 | 0.05 |
| 55° | C. | 0.50 | 0.10 | 0.10 | 0.80 | 0.60 | 0.60 | 0.01 |
| 60° | C. | 0.20 | 0.80 | 1.20 | 2.20 | 1.80 | 2.30 | 0.20 |

Table 2 is a table showing specifications of the S100C reference electrode. Table 3 is a table showing the specifications of the ceramic interface electrochemical reference electrode of the present invention. In view of the results of the above experiments as well as comparing the device (as shown in Table 3) to the specifications of S100C (as shown in Table 2), we find that, the stability, life time, temperature characteristics, and preservations functions are all almost equivalent to a commercial product (S100C), which will be highly beneficial to the developments of electrical sensors. Therefore, from the above results, we propose a new invention that has an interface produced with polytetrafluoroethylene (PTFE) and KCl—the Ceramic Interface Electrochemical Reference Electrode.

TABLE 2

| | |
|---|---|
| Testing Range | 0.00-14.00 pH |
| Temperature Range | 0-100° C. |
| Speed of Effect | 95% less than 1 second |
| Accuracy | ±0.01 pH |
| Stability | stable |

TABLE 3

| | |
|---|---|
| Testing Range | 2.00-12.00 pH |
| Temperature Range | 0-60° C. |
| Speed of Effect | 95% less than 1 second |
| Accuracy | ±0.01 pH |
| Stability | stable |

In conclusion, the ceramic interface electrochemical reference electrode and its production method stated in this application are to provide a type of micro reference electrode that is not required to be stored in solutions as a reference for future developments of sensors.

The examples disclosed for this invention are examples of the preferred embodiments. Alterations or modifications to part of this invention as it may be easily done by persons of ordinary skill in the art are within the scope of patent of this invention.

Summarizing the above descriptions, purposes, techniques, and effects of this invention are significantly unique to the technological characteristics commonly known to the public at the current stage and the practicality of this invention meets the criteria of patent.

What is claimed is:

1. A method for manufacturing a ceramic interface electrochemical reference electrode for use as a component in electrical bio-medical sensors comprising the step of:
obtaining a first powder and a second powder of appropriate sizes;
mixing the first powder and the second powder at an appropriate weight ratio and putting them in moulds;
compressing the powder mixture at an appropriate pressure for a prescribed first time period to form a cake;
heating the compressed powder cake at a predetermined temperature for a prescribed second time period to form a ceramic material;
cooling the material and cutting it into appropriate sizes as needed;
obtaining chloride silver wires which is Ag/AgCl material that have been processed through a first saturated powder solution;
sealing and packaging the cut ceramic material and the chloride silver wired to form a ceramic interface electrochemical reference electrode.

2. The method according to claim 1, wherein the first powder is a dried KCl powder and the second powder is a dried polytetrafluoroethylene powder.

3. The method according to claim 1, wherein the size of the first powder and second powder is between 14.7-29.5 nm.

4. The method according to claim 1, wherein the weight ratio of the first powder and second powder is between 26% and 74%.

5. The method according to claim 1, wherein the appropriate pressure is 200 kg/cm².

6. The method according to claim 1, wherein the prescribed first time period is 5 minutes.

7. The method according to claim 1, wherein the prescribed second time period is 150 minutes and the predetermined temperature is 365° C.

8. A ceramic interface electrochemical reference electrode used as a component on electrical bio-medical sensors, wherein the ceramic interface electrochemical reference electrode is formulated with PTFE and potassium chloride powders with a grain size of 147 um-246 um mixed at a weight ratio of 26:74; after the mixture is compressed, cut, and packaged, the finished ceramic interface electrochemical reference electrode has a sensitivity level to various pH values of 0.0864 mV/pH; the sensitivity levels of a pH sensor component combined with the ceramic electrochemical reference electrode being 57.54 mV/pH; the sensitivity level of the ceramic electrochemical reference electrode under a dry environment for 60 days being 0.141 mV/pH; and the electrochemical reference electrode having good electrical voltage working characteristics under an ambient temperature of 0° C.-60° C.

9. The ceramic interface electrochemical reference electrode according to claim 8, further comprising a mixture of PTFE and KCl powders.

10. The ceramic interface electrochemical reference electrode according to claim 8, further comprising a mixture of PTFE and NaCl powders.

11. The ceramic interface electrochemical reference electrode according to claim 8, further comprising a mixture of PTFE and sodium powders.

12. The ceramic interface electrochemical reference electrode according to claim 8, further comprising a mixture of PTFE and KCl powders, with the size of the KCl powder grains being between 14.7 nm-24.6 nm.

13. The ceramic interface electrochemical reference electrode according to claim 8, further comprising a mixture of PTFE and NaCl powders, with the size of the NaCl powder being grains between 14.7 nm-24.6 nm.

14. The ceramic interface electrochemical reference electrode according to claim 8, further comprising a mixture of PTFE and sodium powders, with the size of the sodium powder grains between 14.7 nm-24.6 nm.

15. The ceramic interface electrochemical reference electrode according to claim 8, further comprising a mixture of PTFE and KCl powders, with a mixture weight ratio of 26:74.

16. The ceramic interface electrochemical reference electrode according to claim 8, further comprising a mixture of PTFE and NaCl powders, with a mixture weight ratio of 26:74.

17. The ceramic interface electrochemical reference electrode according to claim 8, further comprising a mixture of PTFE and sodium powders, with a mixture weight ratio of 26:74.

18. The ceramic interface electrochemical reference electrode according to claim 8, which is a component to be used in combination with an electrical biomedical sensors for the purpose of detecting the micro-variations in biological values, which are indicated by the drifts of electrical voltages.

19. The ceramic interface electrochemical reference electrode according to claim 8, which is a component to be used in combination with an electrical bio-medical sensors with a working temperature between 0° C.-60° C. and used to detect micro-variations in biological values, which are indicated by the drifts in electrical voltages.
